(19) United States
(12) Patent Application Publication
(10) Pub. No.: US 2022/0048572 A1
(43) Pub. Date: Feb. 17, 2022

(54) Vehicle chassis

(71) Applicant: Gordon Murray Design Limited, Shalford (GB)

(72) Inventors: Ian Gordon Murray, Puttenham (GB); Frank Coppuck, Liphook (GB); Andrew John Smith, Shalford (GB)

(21) Appl. No.: 17/274,392

(22) PCT Filed: Sep. 10, 2019
(86) PCT No.: PCT/GB2019/052515

§ 371 Date: Mar. 8, 2021

(30) Foreign Application Priority Data
Sep. 11, 2018 (GB) 1814778.5
Sep. 6, 2019 (GB) 1912845.3

(51) Int. Cl. B62D 23/00; B62D 21/02; B62D 21/10; B62D 21/18; B62D 29/00; B62D 29/04

(52) U.S. Cl. CPC B62D 23/005; B62D 21/02; B62D 29/046; B62D 21/183; B62D 29/008; B62D 21/10

(57) ABSTRACT

We disclose a chassis for a vehicle, comprising an interconnected framework comprising a plurality of tubular sections, and at least one sheet bonded to the framework, wherein the tubular sections are of a non-ferrous metallic composition. The non-ferrous tubular sections have a very thin wall; generally, these sections are made by extrusion, which currently allows for wall thicknesses no thinner than about 2.5 mm. We prefer the wall thickness to be about this level, and ideally no greater than 3 mm. Such a thin-walled tube would usually imply a lower resistance to buckling, but as part of the structural element defined above, we have found that the tube does not buckle and in fact has an impact response that is superior to other alternatives. We therefore prefer that the tubular sections have a profile for which the ratio of the minimum area moment of inertia of its cross section to the square of the unsupported length of the section is less than 2 mm². Another way of expressing this approach is to consider the aspect ratio of the tubular section, i.e. the ratio of its length to its wall thickness. Sections with a high aspect ratio will be more prone to buckling. Given the low elastic modulus of Aluminium, a low aspect ratio has been preferred, but according to the present invention a higher aspect ratio of more than about 100 or 150 is feasible.

### FIELD OF THE INVENTION

The present invention relates to a chassis for a vehicle.

### BACKGROUND ART

For the last 110 years or so, the chassis structures for mass production cars have been made using standard formed metal. In the early 20th century, this was with a separate frame and body design, and during the last 60 years or so a unitary construction (incorporating frame and body) has been adopted.

For the greater part of high volume automobile production history, the material of choice was steel. During the last two decades there has been a move towards aluminium structures in an attempt to reduce the overall vehicle weight with a lighter body-in-white (BIW) assembly.

Aluminium is not a simple solution, however. It has nine times the embodied energy (in terms of the raw material manufacturing process) when compared to steel, so automotive designers generally try to use as little aluminium as possible. Also, although aluminium has a density that is about 3 times less than steel, it has a Young's modulus which is about 3 times less than steel (i.e. aluminium is about 3 times less stiff than steel). This leads to aluminium sections being much larger, and having a thicker wall than the equivalent steel sections, in order to exhibit the same mechanical strength. Larger and heavier sections are mainly used to avoid failure in buckling under crash loads, or excessive flexing under applied loads in torsion.

Current automotive body design practice is to introduce more aluminium sections to stabilise the sections which are flexing or failing. This leads to a much greater volume of aluminium being used, which largely negates the weight advantage of aluminium and leads to a much smaller weight reduction in the BIW structure than might have been expected. The extra embodied energy in the raw material and the extra material costs must still be carried, however.

Base aluminium is more than 3 times more expensive than steel, but when it is used in an automotive BIW structure it is 60%-80% more expensive (depending on aluminium component choice and joining methodology).

Another design and cost issue with automotive aluminium primary structures is that the joining technologies that need to be employed are much more complex, heavy and expensive relative to the simple spot welding processes that can be used to join stamped-steel BIW structures. High levels of stress in structure element joints (nodes) often require complex castings or multi-element designs to reduce the likelihood of fatigue failure, and aluminium sheet joints are normally bonded and riveted.

The noise, vibration and harshness (NVH) qualities of aluminium structures are also not usually as good as steel, so the addition of more NVH materials in aluminium structures adds cost and weight to the overall vehicle structure.

Another issue with aluminium BIW structures is that because base aluminium is not as strong as mild steel (typically 40% the yield strength of steel), high strength aluminium alloys are normally specified and this results in further issues with cost and joint selection. With high strength alloys the heat affected zone from welded joints can often require some form of post weld treatment.

Another issue with welded aluminium structures is resistance to fatigue in the welded joint or node areas. To overcome this complex, heavy and expensive node joints are employed which adds weight and cost to the BIW structure.

With all metallic stamped metal or space frames crash signature and crash repair is an issue. Typically the crash signature from relatively minor events travels through the whole frame and results in localised buckling of unsupported elements which makes crash repair difficult or, at worst, impossible. Aluminium structures are prone to more local deformation and damage than steel structures due to the much lower material modulus value.

Thus, whilst Aluminium is a very good material choice for non-structural or semi-structural outer body panels, most modern metallic BIW structures use some of the outer panels as structural components.

As a result, in our earlier application WO2009/122178 we proposed a three-dimensional framework of metallic tubular members, with composite panel members affixed to the framework to provide triangulation. The resulting chassis provided excellent stiffness due to the triangulation, with a very low overall weight and a low energy cost of production. In practice, the designs that were based on the invention of WO2009/122178 used steel tubes, partly in order to reduce cost and partly to provide the necessary buckling resistance without resorting to large sectional dimensions.

### SUMMARY OF THE INVENTION

Since then, we have found that the composite panel reinforcement is capable of providing the tubular member with significant resistance to buckling. As a result, the large sections associated with aluminium chassis structures are not in fact needed. It is in fact feasible to use smaller-section tubular members of aluminium (or other lightweight alloys) which, on their own, have insufficient resistance to buckling but which as part of a structure braced with composite panels can offer both the necessary stiffness and resistance to deformation under (for example) crash loads.

In addition, comparative testing of steel and lightweight-alloy structures reinforced with a composite panel show that, under deformation, the lightweight-alloy structures absorb more energy than the corresponding steel structures, even when the structures are designed so that their overall strength (i.e. the force needed to initiate crushing) is comparable.

Thus, we propose the use of lightweight low-cost composite sandwich panels to support a non-ferrous, i.e. a lightweight-alloy-section, frame. The panels can be bonded to the frame using a low-modulus adhesive. The quantity of aluminium or other alloy used can be reduced to an absolute minimum as the low cost, low energy composite panels contribute a large proportion of the BIW stiffness and the structure's crashworthiness.

The present invention therefore provides a chassis for a vehicle, comprising an interconnected framework comprising a plurality of tubular sections, and at least one sheet bonded to the framework, wherein the tubular sections are of a non-ferrous metallic composition.

We prefer that the non-ferrous tubular sections have a very thin wall. Generally, these sections are made by extrusion, and this process currently allows for wall thicknesses no thinner than about 1.6 mm. We prefer the wall thickness to be about this level, such as about 1.5-2 mm, and ideally no greater than 3 mm.

Such a thin-walled tube would usually imply a lower resistance to buckling. However, as part of the structural element defined above, we have found that the tube does not buckle and, indeed, has an impact response that is superior to other alternatives. We therefore prefer that the tubular sections have a profile for which the ratio of the minimum area moment of inertia of its cross section to the square of the unsupported length of the section is less than 2 mm². This would imply a low resistance to buckling on the part of the tube alone, but we have found that the structure as a whole is sufficiently resistant.

Another way of expressing this approach is to consider the aspect ratio of the tubular section, i.e. the ratio of its length to its wall thickness. Sections with a high aspect ratio will be more prone to buckling. Given the low elastic modulus of Aluminium, a low aspect ratio has been preferred, but according to the present invention a higher aspect ratio of more than about 100 or 150 is feasible.

### BRIEF DESCRIPTION OF THE DRAWINGS

An embodiment of the present invention will now be described by way of example, with reference to the accompanying figures in which;

FIG. 1 shows the results of an impact test of various test pieces;

FIG. 2 shows the geometric design of the test pieces used in FIG. 1a, and

FIG. 3 shows the cross-section of the aluminium test piece used for FIG. 1.

### DETAILED DESCRIPTION OF THE EMBODIMENTS

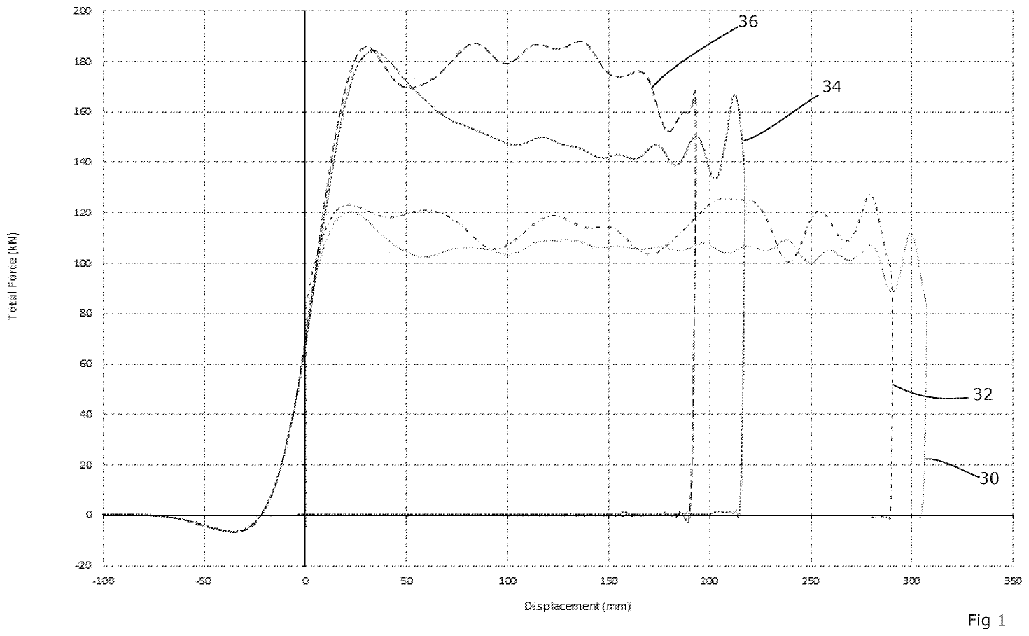

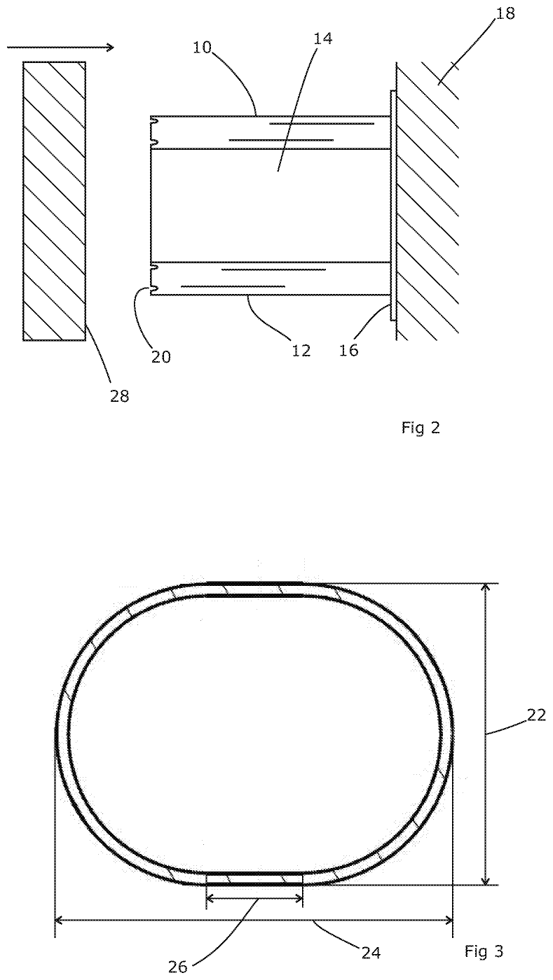

FIG. 1 shows the results of an impact test applied to a variety of test pieces according to the general geometric layout shown in FIG. 2. This layout comprises a pair of parallel tubular sections 10, 12 which are joined by a flat panel 14. This arrangement is mounted perpendicularly to a baseplate 16, which is attached to a solid surface 18. The tubes 10, 12 have a pattern of notches 20 in their end sections, to act as crush initiators and ensure that deformation is controlled.

The steel tubes were circular-section tubes 498 mm long and 63.5 mm outside diameter. The Aluminium tubes were an oval profile shown in FIG. 3, 508 mm long, with a minor diameter 22 of 63.5 mm and a major diameter 24 of 83.5 mm. The difference is achieved by a 20 mm wide flat section 26 to define an oval instead of a circular section.

A sled 28 with a mass of 780 kg is impacted linearly onto the test piece in a direction parallel to the tubular members 10, 12, to crush the test piece against the solid surface. The sled is projected with a speed of 9.5 ms⁻¹, giving an impact energy of 35.2 kJ. This simulates a 50 kph Full Frontal Barrier (FFB) full vehicle crash test. FIG. 1 shows the results of four scenarios, as follows:

| | | | | Wall |
|---|---|---|---|---|
| | | | Mass | thickness |
| Line | Tube | Panel | (kg) | (mm) |
| 30 | Steel | Absent | 2.7 | 1.5 |
| 32 | Steel | 1.8 mm | 4.4 | 1.5 |
| | | Steel | | |
| 34 | Steel | Carbon | 3.7 | 1.5 |
| | | fibre | | |
| 36 | Aluminium | Carbon | 2.9 | 2.5 |
| | | fibre | | |

The x axis of FIG. 1 shows the displacement of the sled 28 in mm, and the y axis shows the total force exerted in kN. As the sled is provided with the same impact energy in each case, the total enclosed area of the four traces is the same but the profiles differ. Notably, the carbon-fibre reinforced test pieces exhibited a higher crush force than both the unsupported steel tubes 30 and the tubes with a steel panel 32. The addition of the steel panel to the steel tubes appears to make little difference.

Second, the aluminium tubes reinforced with a carbon-fibre panel showed the same initial impact force of about 185 kN, but maintained that force more consistently and for much longer into the impact than the steel tubes reinforced with a carbon-fibre panel. The latter line 36 drops off quickly to around 140-150 kN whereas the Aluminium-tubed test piece stays in the 170-190 kN range for much longer. This suggests that the Aluminium tubular sections and the reinforcing panel are co-operating under deformation in a manner that the steel tubular sections are not.

It is also notable that Euler buckling load of the Aluminium tubular sections is considerably lower than that of the steel tubular sections. Taking the well-known Euler equation for the collapse of a column under an axial load, i.e.

$${P}_{cr} = \frac{{π}^{2} EI}{{( KL )}^{2}}$$

where
P_{cr}=Euler's critical load (the longitudinal compression load on a column),
E=the modulus of elasticity of the column material,
I=the minimum area moment of inertia of the cross section of the column,
L=the unsupported length of column, and
K=the column effective length factor, reflecting the boundary conditions of the column,

and approximating the Aluminium tubes as a circular section with an outside diameter of 63.5 mm and a wall thickness of 2.5 mm, the tubular sections have buckling characteristics of:

| Tube | E (GPa) | I (mm⁴) | P_{cr} (kN) |
|---|---|---|---|
| Steel | 200 | 281000 | 559 |
| Aluminium | 69 | 446000 | 295 |

The calculation has been on the basis of K being 2, corresponding to one fixed end and one free end.

Thus, the Aluminium tube has a buckling strength which is considerably lower than the steel and which is nominally inadequate relative to the failure strength of the test piece, after allowing a suitable safety margin. To increase the buckling strength of the Aluminium tube to match that of the steel tube, the wall thickness would have to be increased to 5.5 mm. Comparing these tube designs:

| | Wall | | Moment | Geometric | |
|---|---|---|---|---|---|
| | thickness | Length | of inertia | Ratio | Aspect |
| Tube | (mm) | (mm) | (mm⁴) | (mm²) | Ratio |
| Steel | 1.5 | 498 | 281000 | 1.1 | 332 |
| Equivalent | 5.5 | 508 | 847000 | 3.3 | 93 |
| Aluminium | | | | | |
| Thin | 2.5 | 508 | 446000 | 1.7 | 203 |
| Aluminium | | | | | |

The geometric ratio noted is intended to reflect the influence of the tube geometry on the buckling performance. It is the ratio of the minimum area moment of inertia of the cross section of the tubes to the square of their unsupported length. As can be seen, the test piece of this-walled Aluminium tube has a ratio less than 2 mm², and closer to that of a steel tube than that of an Aluminium tube designed to match the buckling strength of the steel tube. Likewise, the aspect ratio of tube, which is considerably easier to determine in practice, is well above the sub-100 level of the Aluminium tube designed to be equivalent in mechanical strength to the steel tube and is distinctly over 150. Given that the Aluminium has an elastic modulus 2.85 times less than that of steel, the fact that a test piece made up of tubes with an aspect ratio of only 1.6 times less and a geometric ratio of only 1.5 times more achieves the same yield force and a better impact absorption profile indicates that a useful effect is present in the selection of thin-walled Aluminium tubular sections in this context.

Thus, when combined with a supporting composite panel, Aluminium sections can be provided with a considerably thinner wall than is apparently necessary based on a consideration of their resistance to buckling. This saves material usage, reducing the environmental impact of the vehicle, reduces the weight of the vehicle, and reduces the material cost.

It will of course be understood that many variations may be made to the above-described embodiment without departing from the scope of the present invention.

1. A chassis for a vehicle, comprising an interconnected framework comprising a plurality of tubular sections, and at least one sheet bonded to the framework, wherein the tubular sections are of a non-ferrous metallic composition.

2. The chassis according to claim 1 in which the non-ferrous tubular sections have a wall thickness no greater than 3 mm.

3. The chassis according to claim 1 in which the non-ferrous tubular sections have a profile for which the ratio of the minimum area moment of inertia of its cross section to the square of the unsupported length of the section is less than 2 mm².

4. The chassis according to claim 1 in which the non-ferrous tubular sections have an aspect ratio of more than about 100.

5. The chassis according to claim 1 in which the non-ferrous tubular sections have an aspect ratio of more than about 150.

6. The chassis according to claim 1 in which the sheet is of a composite material.

7. The chassis according to claim 6 in which the sheet is a carbon-fibre composite.
